(19) United States
(12) Patent Application Publication
(10) Pub. No.: US 2006/0176506 A1
(43) Pub. Date: Aug. 10, 2006

(54) Network interfacing system for PictBridge® printer

(76) Inventors: Ben Lin, Taipei (TW); Chao-Fan Wang, Taipei City (TW)

Correspondence Address: LIN & ASSOCIATES INTELLECTUAL PROPERTY, P.O. BOX 2339, SARATOGA, CA, 95070-0339, US

(21) Appl. No.: 11/100,730

(22) Filed: Apr. 7, 2005

(30) Foreign Application Priority Data
Feb. 5, 2005 (TW) 094103914

(51) Int. Cl. G06F 3/12

(52) U.S. Cl. 358/1.15; 358/1.13

(57) ABSTRACT

A password input and verification method is provided to prevent the disclosing of the password from peeping. The method is easy to learn, transparent to the users, and requires no hardware change and only minor software modification. The method allows a user to enter a much longer string of characters when he or she is asked for the password. The user is then authenticated if the actual password is embedded as a whole anywhere within the input string. The method also provides a mechanism called prohibition key. A prohibition key is a pre-determined character that, when present in the user input string, the user is not authenticated regardless of whether the actual password is contained in the input string or not.

### BACKGROUND OF THE INVENTION

1. Field of the Invention

The present invention generally relates to local area network devices, and more particularly to a device and a related driver for making prints on a PictBridge® compliant printer over a local area network.

2. The Prior Arts

As the digital cameras are gaining widespread popularity, the printer industry is responding to the trend with the introduction of the so-called photo printers, printers designed specifically for printing digital photos. To simplify the printing of digital photos, these printers usually provide additional interface mechanisms other than the traditional parallel and Universal Serial Bus (USB) ports. Some could directly accept various types of memory cards and some could allow direct print from digital cameras over wireless links. However, similar to any emerging product, digital camera and printer vendors have their proprietary connectivity protocols. To resolve the lack of standard, the Camera and Imaging Products Association (CIPA) of Japan therefore has proposed a standard protocol CIPA-DC-001 (also known as PictBridge®) so that any PictBridge® compliant digital camera (or digital camcorder, camera phone, etc.) could make prints directly from any PictBridge® compliant printer over a direct connection.

Even though the PictBridge® protocol has been widely accepted; there are still millions of digital cameras, digital camcorders, and camera phones not supporting this protocol. Besides, the design of the PictBridge® protocol is for personal users and, therefore, it specifies a one-to-one direct connection via a USB cable between a PictBridge® input device and a PictBridge® output device. In other words, the PictBridge® protocol is not designed for sharing a single PictBridge® compliant printer concurrently among multiple PictBridge® compliant cameras, camcorder, or camera phones.

Due to these shortcomings, therefore, there is an idea to integrate a PictBridge® compliant printer into a local area network (LAN) via an interfacing device so that it could become a shared resource over the LAN. Any device connected to the LAN, such as computers, multi-mode handsets supporting 802.11 a/b/g protocols, or PDAs, could all print their digital photos, image files, and other documents from the PictBridge® compliant printer via the interfacing device.

This interfacing device in some sense is very similar to a traditional print server device, but they are actually very different. FIG. 1 is a schematic diagram showing an application environment of a conventional print server device. As illustrated, a printer 40 is connected to a print server device 30 via an appropriate cable such as a parallel or USB cable. The print server device 30 in turn is connected to a LAN 10. Over the LAN 10, there are a number of computing devices 20 working as clients to the print server device 30. These computing devices 20 are equipped with a driver program 202 supporting the printer 40. When making prints from a computing device 20 under the so-called peer-to-peer mode, the document to be printed is first turned into a print job (not numbered) and then put into a print queue 203 by the driver program 202. The print job is then transmitted to the print server device 30 by a network driver 201 using a network communications protocol, and finally printed out from the printer 40. Making prints under another so-called server-based print queue mode is also very similar. The difference basic lies in that the print queue is on a network server 21, instead on the computing device 20. Therefore under the server-based print queue mode, the print job is transmitted from the computing device 20 to the network server 21, put into a print queue there, and transmitted again from the network server 21 to the print server device 30. Please note that, regardless of whether it is the peer-to-peer mode or the server-based print queue mode, from the view point of the computing device 20, the printing is basically done, just like printing on a local, direct-attached printer. The difference is that the LAN 10 is used to send the print job to the print server device 30 and the printer 40, instead of via the computing device 20's parallel or USB port. In other words, the print server device 30 is only a simple device without much intelligence.

FIG. 2 is a schematic diagram showing the interaction between a PictBridge® compliant digital camera and a PictBridge® compliant printer. As illustrated, the PictBridge® compliant digital camera and printer is connected by a USB cable therebetween and they would function both as client and server to each other according to the PictBridge® protocol. When the digital camera wants to print a digital photo, its Print Client makes a request to the Print Server of the printer. When the printer is ready to make the print, its Storage Client requests the Storage Server of the digital camera to provide the digital photo to be printed. In addition, when the digital camera and the printer are connected initially, the digital camera would collect information about the printer's capability via a negotiation process. All these communications cannot be conducted by a conventional print server device within a conventional network printing infrastructure.

### SUMMARY OF THE INVENTION

To overcome the foregoing inadequacy of the conventional network printing infrastructure in interfacing a PictBridge® compliant printer to a LAN, the present invention provides an interfacing device and an associated method in the form of a driver program. A computing device equipped with the device driver and connected to a LAN could make prints on any PictBridge® compliant printer connected to the LAN via the interfacing device.

The interface device is connected via an USB cable to a PictBridge® port of the PictBridge® compliant printer. The built-in firmware of the interfacing device would conduct negotiation and the execution of print jobs with the PictBridge® compliant printer according to the PictBridge® protocols. In a way, the interfacing device behaves exactly like a PictBridge® compliant digital camera to the PictBridge® compliant printer. The interfacing device also possesses the required functions and interfaces for interconnection with a LAN (such as a LAN conforming to the 802.11-series of standards).

For a computing device on the LAN to make prints on the PictBridge® compliant printer via the LAN and the interfacing device, a “universal” driver computing device appropriate for the computing device's hardware and software platforms has to be installed on the computing device. It is called a “universal” driver because the driver does not require the PictBridge® compliant printer to be of specific brand or model, or to have specific capabilities or functions.

When a document or digital photo is printed from the computing device, the driver transforms the data to be printed into having a bitmap format and the result of transformation is sent to the interfacing device over the LAN. The interfacing device then, based on its knowledge of the characteristics, capabilities, and functions of the PictBridge® compliant printer during negotiation, requests the PictBridge® printer to print out the bitmapped data.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing an application environment of a conventional print server device.

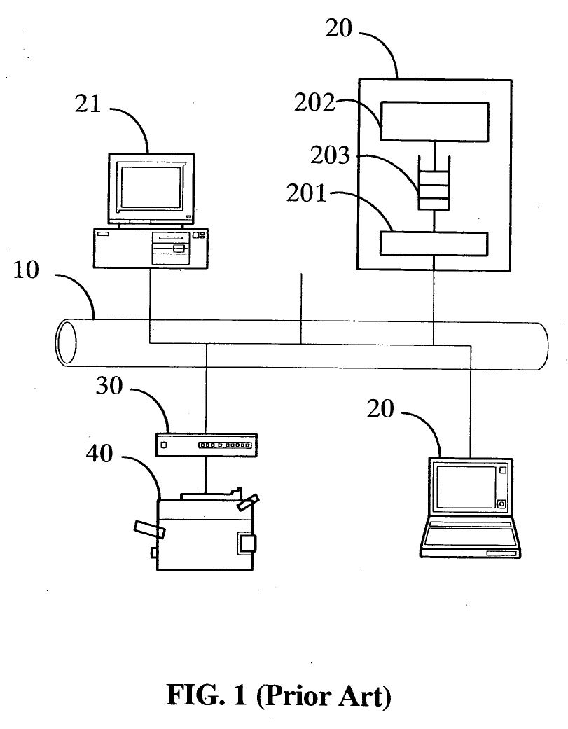

FIG. 2 is a schematic diagram showing the interaction between a PictBridge® compliant digital camera and a PictBridge® compliant printer.

FIG. 3a is a schematic diagram showing the application environment of a first embodiment of the present invention.

FIG. 3b is a schematic diagram showing the application environment of a second embodiment of the present invention.

### DETAILED DESCRIPTION OF THE PREFERRED EMBODIMENTS

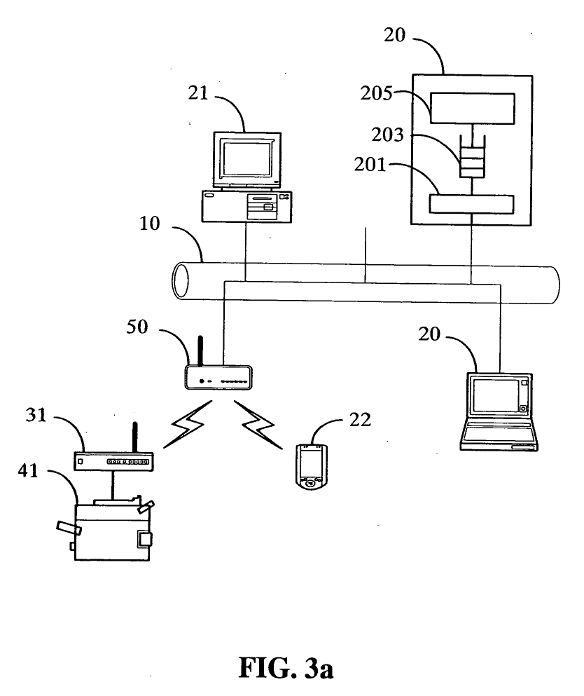

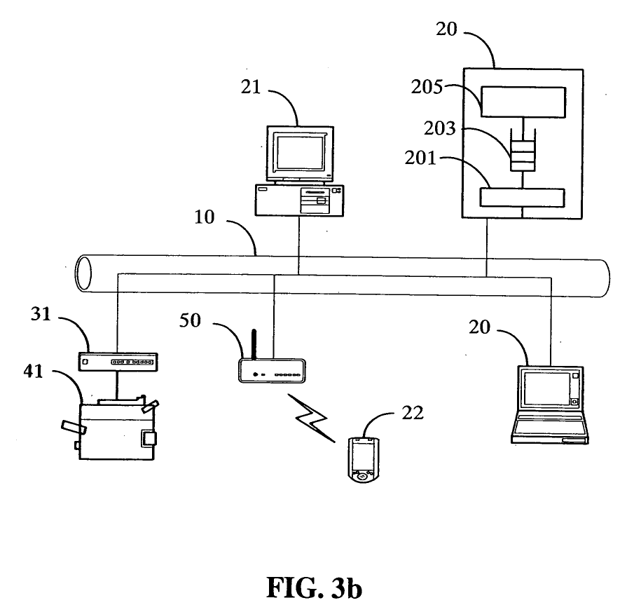

As described above, the present invention mainly contains two parts: an interfacing device and an associated method implemented as a driver program. FIG. 3a is a schematic diagram showing the application environment of a first embodiment of the present invention. In the present embodiment, the interfacing device 31 is connected to a PictBridge® compliant printer 41 using an USB cable (not numbered). A PictBridge® compliant printer usually has two ports: one is a parallel or USB port for connecting to a computing device; the other one is an USB port specifically for connection with a PictBridge® compliant device (this port is referred to as the PictBridge® port in this specification). The interfacing device 31 therefore has the USB cable connected to the PictBridge® port of the PictBridge® compliant printer 41.

In the present embodiment, the interfacing device 31 has a wireless network interface conforming to a wireless LAN communications protocols such as 802.11 a/b/g standard. The interfacing device 31 itself is not an access point and it has to establish a wireless link with an access point 50 in order to connect to the LAN 10. In terms of establishing the wireless link, the interfacing device 31 is exactly like an ordinary wireless station and therefore has to be configured with appropriate parameters such SSID and WEP compatible with those of the access point 50. The interfacing device 31 usually has a number of indicators such as LEDs or a small LCD screen for showing the operation status of the interfacing device 31. As the configuration of the interfacing device is exactly like any conventional wireless station, the details are omitted here for simplicity sake.

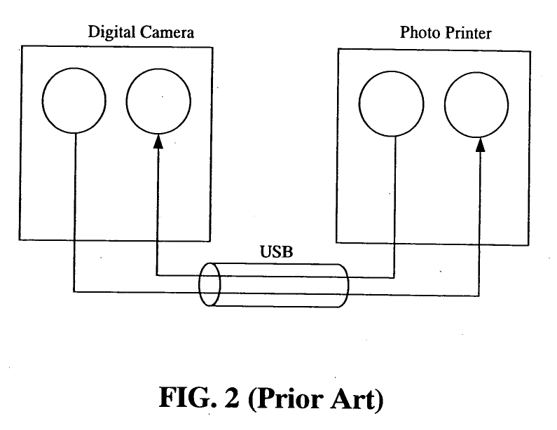

The interfacing device 31 in the present embodiment is a self-contained and independent device. In some other embodiments, the interfacing device 31 could also be integrated with network devices. One such example is a device functioning both as the interfacing device 31 of the present invention and as an access point. When the interfacing device 31 is an independent device as in the present embodiment, it has an identical architecture to an ordinary computing device. It may contain a processor, a flash memory (for the storage of the firmware code), a RAM, I/O interfaces, and a bus for connecting all these elements. The firmware of the interfacing device 31 has two major functions. On one hand, from the viewpoint of the PictBridge® compliant printer, the firmware makes the interfacing device 31 behave just like a PictBridge® compliant digital camera as depicted in FIG. 2. In other words, the firmware functions both as the Print Client and the Storage Server, and interacts with the Print Server and the Storage Client of the PictBridge® compliant printer 41 in accordance with the PictBridge® protocol. On the other hand, the firmware makes the interfacing device 31 behaves just like an ordinary print server device so that a user could utilizes the existing network printing procedures, protocols (such as NetBEUI, TCP/IP, RAW, LPR, etc.), and network drivers to make prints from computing devices 20, 21, and 22 on the PictBridge® compliant printer 41.

After the interfacing device 31 is connected to the PictBridge® compliant printer 41 (the negotiation would be conducted) and a wireless link to the access point 50 is established, a driver 205 has to be installed on the computing devices 20, 21, and 22. From the viewpoint of the operating system on the computing devices 20, 21, and 22, the driver 205 is no different from the printer driver of any printer. Assuming that the computing device 20 is running one of the Windows® operating systems, a user therefore could follow the usual Windows® “Add New Printer” procedure for installing the driver 205. The driver 205 is platform-dependent and, therefore, different computing devices would require different types of drivers 205.

When making prints, the driver 205 functions similarly to ordinary printer drivers. Using the peer-to-peer mode as example, an application program on the computing device 20 chooses the driver 205 as the targeted printer device and activates the printing function. The driver 205 then converts the printed data delivered to it from the application program into having a pre-determined bitmap format (such as BMP, JPEG, TIFF, GIF, etc.) and puts the print job associated with the bitmapped data into a print queue 203.. A network driver 201 then transmits the print job and the associated bitmapped data to the interfacing device 31 via network communications protocols. The interfacing device 31 then follows the PictBridge® protocol to print the bitmapped data on the PictBridge® printer 41. The foregoing process is also very similar to that happened in the server-based-print-queue mode. The difference only lies in that, in the server-based-print-queue mode, the print queue is on a network server 21, instead of on the computing device 20. In another embodiment illustrated in FIG. 3b, which is a schematic diagram showing the application environment of a second embodiment of the present invention, the interfacing device 31 is connected to the LAN 10 via a wired interface. Besides that, all configurations and procedures are identical to the first embodiment. In other words, the interfacing device 31 could have a wired network interface, a wireless network interface, or both.

Although the present invention has been described with reference to the various embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A network interfacing system for a PictBridge® compliant printer comprising a driver program and an interfacing device, said interfacing device connected to a PictBridge® port of said PictBridge® compliant printer via an USB cable, said interfacing device connected to a local area network via an network interface, said driver program installed within an operating system on a computing device connected to said local area network as a printer driver, said network interfacing system characterized in that:
said driver program converts a printed data into having a pre-determined bitmapped format when an application program on said computing device makes a print with said driver program as a targeted device;
a network driver of said operating system transmits said printed data having said pre-determined bitmapped format to said interfacing device following a communications protocols compatible to said interfacing device via said local area network; and
said interfacing device prints said printed data on said PictBridge® compliant printer via said USB cable following PictBridge® protocols.

2. The network interfacing system for a PictBridge® compliant printer as claimed in claim 1, wherein said interfacing device comprises a processor, a flash memory, a RAM, a plurality of I/O interfaces, and a bus connecting the foregoing elements, and said flash memory comprises a firmware controlling the operation of said interfacing device.

3. The network interfacing system for a PictBridge® compliant printer as claimed in claim 1, wherein said network interface is a wired network interface.

4. The network interfacing system for a PictBridge® compliant printer as claimed in claim 1, wherein said network interface is a wireless network interface.

5. The network interfacing system for a PictBridge® compliant printer as claimed in claim 1, wherein said pre-determined bitmap format is selected from the group consisting of BMP, JPEG, TIFF, and GIF.
